(19) United States
(12) Patent Application Publication
(10) Pub. No.: US 2005/0050099 A1
(43) Pub. Date: Mar. 3, 2005

(54) System and method for extracting customer-specific data from an information network

(75) Inventors: David Bleistein, Damascus, MD (US); Aswin Reddy Majjiga, Leesburg, VA (US); David Moyers, Columbia, TN (US)

Correspondence Address: FOLEY AND LARDNER;SUITE 500, 3000 K STREET NW, WASHINGTON, DC, 20007, US

(73) Assignee: GE Information Systems

(21) Appl. No.: 10/682,782

(22) Filed: Oct. 10, 2003

Related U.S. Application Data
(60) Provisional application No. 60/497,018, filed on Aug. 22, 2003.

(51) Int. Cl. G06F 7/00

(52) U.S. Cl. 707/104.1

(57) ABSTRACT

A system, and method of extracting data includes: receiving a data file having metadata from a data source; obtaining a first document based at least on the data file; selecting key field information from a first information database based at least in part on the metadata of the data file; obtaining a second document based on the key field information; extracting key field data, corresponding to the key field information, from the first document based on the second document; and sending the key field data to a second information database.

### CROSS-REFERENCE TO RELATED PATENT APPLICATIONS

The present application claims priority to U.S. Provisional Application Ser. No. 60/497,018 entitled, “A System and Method For Extracting Customer-Specific Data From an Information Network,” filed Aug. 22, 2003, the disclosure of which is incorporated by reference herein.

### BACKGROUND OF THE INVENTION

A broker is typically a software module or group of modules that may be running on one or multiple computers in an information network, and is configured to correctly route data files based on metadata associated with those files. The metadata may include such parameters as a filename, receiver and sender information, transaction/document type (e.g., APRF, or application reference), file format, a header or document control number (e.g., SNRF, or sender reference), a service reference (e.g., SREF), among other things, as is known in the art. There is a need for quickly, efficiently, and safely (i.e., without risking contamination or infection of a file) extracting information from a stream of data files passing through an information network.

A broker emulator is typically a software module that may be placed in series with the broker so that the data files that pass through the broker also pass through the broker emulator, and the contents of the data files are accessible and readable by the broker emulator. The broker emulator may be configured to “flag” or set aside data files that it finds relevant or important. For example, the emulator may be programmed to flag data files coming from a particular trading partner (as specified by the client), such as Wal-Mart. Or, more specifically, the emulator may be programmed to flag purchase order type data files coming from Wal-Mart. The emulator may be configured to then open the flagged file and extract important information, such as purchase order number (or invoice number or remittance number, etc.), product identifier information (such as UPC number or qualitative description), a correspondence address of the trading partner, a date of sending or receipt, or other such information. This information is then sent to a database for storage and/or further processing/analysis. The flagged file is then closed and re-routed to the intended recipient via the broker.

### SUMMARY OF THE INVENTION

The inventors have recognized at least two problems with this method. First, in opening and closing the relevant/important file for data extraction, there is some chance of corrupting or tampering with the file, such as by a virus or faulty software or hardware. Second, the opening, closing, and processing/analysis of the file is very time-intensive. Depending on how many such data files are flagged as relevant or important, delivery of the files to the intended recipient may be unacceptably delayed. The present invention aims to solve one or more of these and other problems.

In one embodiment of the present invention, a method of extracting data may comprise: receiving a data file from a data source, the data file having metadata comprising at least one of file name, sender identification information, receiver identification information, transaction type, and file format; obtaining a first document based at least on the data file; selecting key field information from a first information database based at least in part on the metadata of the data file; obtaining a second document based on the key field information; extracting key field data, corresponding to the key field information, from the first document based on the second document; and sending the key field data to a second information database.

In another embodiment of the present invention, a method of gathering customer-specific data from an information network, the information network having a broker configured to route a data file based at least in part on metadata associated with the data file, may comprise: reading the metadata in a broker emulator located in series with the broker; obtaining first filter criteria at the broker emulator; comparing the first filter criteria with the metadata; if the metadata satisfies the first filter criteria, performing the following: sending the metadata to a report collector connected to the broker; comparing second filter criteria with the metadata; if the metadata satisfies the second filter criteria, performing the following: instructing the broker emulator to copy the data file associated with the metadata; and at least one of translating and extracting data from the data file based at least in part on key field information.

In another embodiment of the present invention, a method of gathering customer-specific data from an information network, the information network having a broker configured to route a data file based at least in part on metadata associated with the data file, may comprise: reading the metadata in a broker emulator located in series with the broker; obtaining filter criteria at the broker emulator; comparing the filter criteria with the metadata; and if the metadata satisfies the filter criteria, at least one of translating and extracting data from the data file based at least in part on key field information input by a customer.

In another embodiment of the present invention, a system for extracting data from a data file having metadata comprising at least one of file name, sender identification information, receiver identification information, transaction type, and file format, comprising: a data analyzer configured to create a first document based at least on the data file; an information database connected to the data analyzer and configured to store at least two key field information instances and a mapping of the key field information instances as a function of the metadata; and a data extractor connected to the data analyzer and configured to: a) select a key field information instance stored in the information database based on the mapping; b) create a second document based on the key field information instance; and c) extract key field data, corresponding to the key field information, from the first document based on the second document.

In another embodiment of the present invention, a system for gathering customer-specific data from an information network, may comprise: a broker configured to route a data file based at least in part on metadata associated with the data file; an information database configured to store filter criteria; a broker emulator connected to the information database and configured: a) to read the metadata of the data file; b) to compare the metadata to the filter criteria; and c) if the metadata satisfies the filter criteria, to copy the data file; and a translator configured to at least one of translate the copy of the data file and extract data from the copy of the data file.

The present invention may include a program product comprising machine-readable program code for causing, when executed, a machine to perform any of the above method steps.

### BRIEF DESCRIPTION OF THE DRAWINGS

FIG. 1 shows a system diagram of a preferred embodiment of the present invention.

FIG. 2 shows a system diagram including the translator/extractor shown in FIG. 1.

FIG. 3 shows a system diagram of another preferred embodiment of the present invention.

FIG. 4 shows a flow chart of a preferred embodiment of the present invention.

FIG. 5 shows a flow chart of another preferred embodiment of the present invention.

FIG. 6 shows a flow chart of another preferred embodiment of the present invention.

### DETAILED DESCRIPTION OF PREFERRED EMBODIMENTS

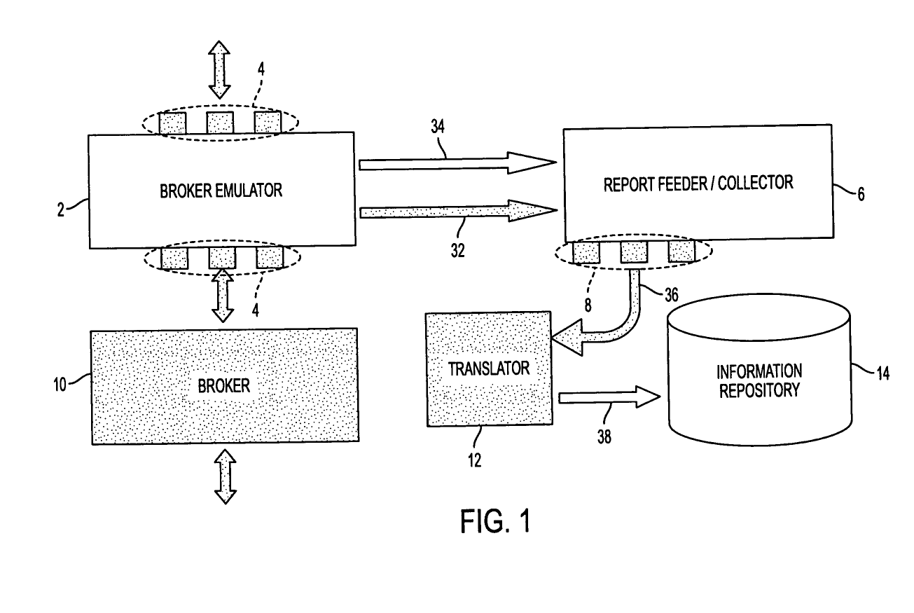

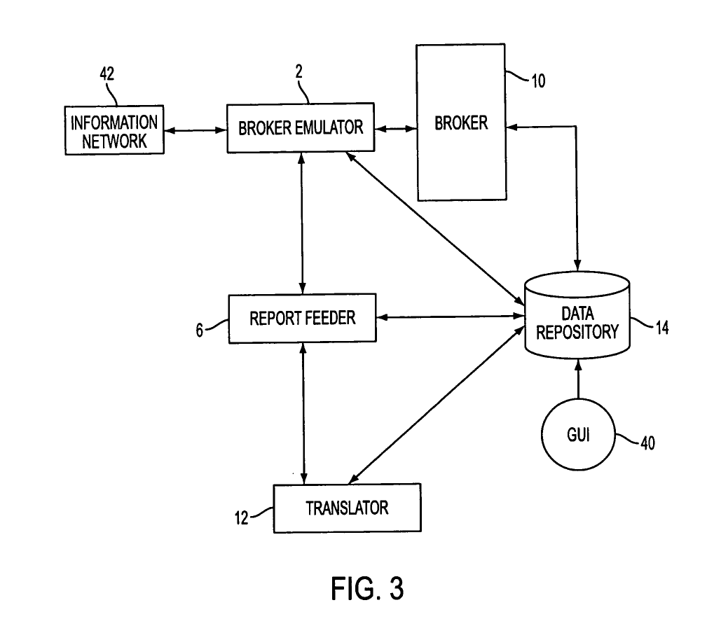

Referring now to FIGS. 1 and 3, a method, software, and system are provided for a broker emulator 2, a report feeder or collector 6, a translator or extractor 12, and an information repository or database 14. The broker emulator 2 is schematically connected to the broker 10, so that data files going to or from the broker 10 (via information network 42, shown in FIG. 3) also pass through the broker emulator 2 (as shown by the arrow directions). The broker emulator 2 may be part of the software being run by the client, so the broker emulator 2 may be connected to the broker 10 on either the same or different side of the broker 10 as the information database to (or from) which the data files are being routed by the broker 10. As shown, the broker emulator 2 may contain software adapters or modules 4 capable of emulating different broker systems 10, both for receiving and transmitting data files or documents.

Schematically, the report feeder/collector 6 is connected to the broker emulator 2, so that data files may be successfully routed through the broker 10 and broker emulator 2 without passing through the report feeder/collector 6. The report feeder/collector 6 may contain software adapters or modules 8 capable of allowing the report feeder/collector 6 to connect to or utilize different translators/extractors 12. The report feeder/collector 6 is schematically connected to (i.e., there is an information connection to) the translator/extractor 12.

The translator/extractor 12 is schematically connected to the information repository or database 14. In fact, the information database 14 may also be schematically connected to the broker emulator 2 and/or the report feeder/collector 6. In a typical implementation of this embodiment, the broker 10, broker emulator 2, report feeder/collector 6, and translator/extractor 12 all exist as software modules being run on the client's computer, and the information database 14 also exists on the client's computer. Alternatively, the client may have a business relationship with a third party, in which case some of the modules 2, 6, 10, 12, and/or database 14 may exist on the third party's computer.

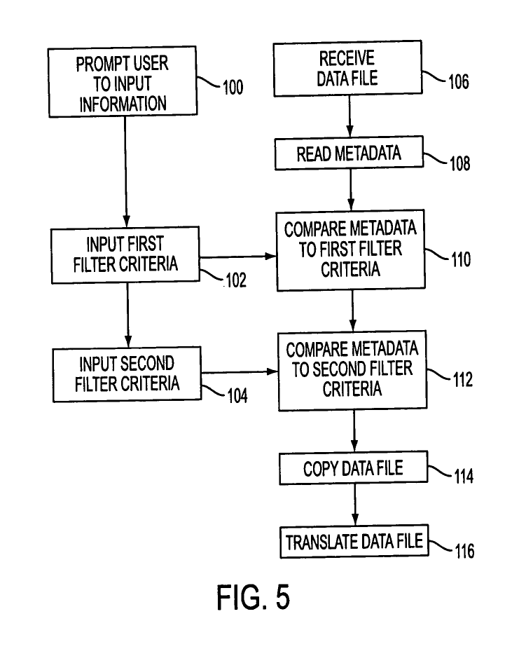

Referring now to FIG. 5, the software/method according to the present invention may be operated as follows. Via a graphical user interface (GUI 40, shown in FIG. 3) run by the software, the client is prompted to input information in step 100. The client then enters information in step 102, such as first filter criteria, as to which data files the broker emulator 2 should flag. For example, the client may request that the broker emulator 2 flag data files coming from Wal-Mart. In step 104, the client may also enter second filter criteria as to which data files the report feeder/collector 6 should request and collect, as will be described later. The first and second filter criteria information are stored in the information database 14. Next, the broker emulator 2 accesses the first and second filter criteria information. The broker emulator 2 receives a data file passing through the emulator 2 in step 106, reads the metadata of the data file in step 108, compares the metadata to the first filter criteria information in step 110, and flags those files that satisfy the first filter criteria. Next, the broker emulator 2 sends a report, such as a copy of the metadata or a portion of the metadata, of each flagged data file to the report feeder/collector 6. (This metadata is shown by arrow 34 in FIG. 1.) The report feeder/collector 6 accesses the second filter criteria information from the information database 14, reads the report or metadata sent from the broker emulator 2, and compares the report or metadata with this second filter criteria in step 112. If the report or metadata satisfies this second filter criteria, the report feeder/collector 6 may request the full data file from the broker emulator 2, in which case the broker emulator 2 may copy the data file in step 114 and send the copy to the report feeder/collector 6. (This copy of the original unchanged data file is shown by arrow 32 in FIG. 1.)

Next, in step 116, the report feeder/collector 6 may send the unchanged copy of the data file to the translator/extractor 12, which may translate and/or extract information from the data file. (This copy of the original unchanged data file is shown by arrow 36 in FIG. 1.) More details about the translator/extractor 12 will be discussed with respect to another embodiment of the present invention. The information translated or extracted by the translator/extractor 12 may then be sent to the information database 14 for storage and/or further analysis. (This extracted data/information is shown by arrow 38 in FIG. 1.)

In another embodiment, as shown in FIG. 3, instead of the translator/emulator 12 sending the translated/extracted information directly to the information database 14, it may first send the translated/extracted information back to the report feeder/collector 6, which subsequently feeds the translated/extracted information to the information database 14. Further, the report collector/feeder 6 could pair the translated/extracted information with the copy of the full data file and feed these together to the information database 14. Thus, if and when analysis is performed on the information contained in the information database 14, analysis can be done much more quickly on the translated/extracted information, because the translated/extracted information presumably contains all the information that the client considers relevant or pertinent. However, if the client at a later time determines that he wants other information, not included in the file's translated/extracted information, then the full copy of the data file will be available for analysis.

The client may enter a single set of filter criteria (such as the first filter criteria), with the broker emulator 2 and the report feeder/collector 6 obtaining a first filter criteria and a second filter criteria therefrom, or the client may separately enter first filter criteria for the broker emulator 2 and second filter criteria for the report feeder/collector 6. Further, all of the filter criteria may be sent to the broker emulator 2, with the broker emulator 2 performing all initial filter operations, and a copy of the full data file may then be sent directly to the translator/emulator 12, in which case the report feeder/collector 6 may be entirely disposed with.

Further, in the embodiment in which the emulator does a first cut using the first filter criteria and the report feeder/collector 6 does a second cut using the second filter criteria, the emulator 2 may, alternatively, send a full copy of the data file to the report feeder/collector 6 if the metadata of the data file satisfies the first filter criteria. In such an embodiment, the report feeder/collector 6 need not request the full copy of the data file if the metadata satisfies the second filter criteria; it will already have the copy. In another embodiment, as shown in FIG. 3, the information database 14 to which the translator 12 or report feeder/collector 6 sends the extracted data may be the same information database to which the broker 10 directs incoming data files or documents.

This invention solves the above stated problems in the following ways. First, by sending a copy of the data file (as opposed to the original data file) to the translator/extractor 12, where the file is opened and information translated and/or extracted from the file, there is little or no chance that the original data file is corrupted, tampered with, or contaminated. Second, by translating/extracting information from a copy of the full data file, brokering or sending of the original data file need not be detained or held up. Thus, the present invention provides for the time-saving advantages of parallel processing. Further, these advantages become more pronounced where the report feeder performs some or all of the filtering operations, as discussed.

Additionally, there is frequently a business need to track fields in a document by a given standard, and to track documents and notify clients in accordance with client-based requirements. In extracting information from the flagged data files to facilitate client tracking, there may be several problems. First, the flagged data files may be in one of several EDI (Electronic Data Interchange) formats, such as XML (extensible mark-up language), EDIFACT, ANSI X12, or flat file format (such as CSV, or comma separated values). The flagged data files may be translated into a standard format, such as XML, which may be different from their original format, before information is extracted from them. Second, the data that a client desires to extract from flagged data files may differ, depending on who sent the data file, its file format, the time and date of sending, and so forth (all of which are indicated by the content of the metadata). In other words, the data that a client desires to extract from flagged data files may depend on the content of the metadata. For example, assume that the client is a distributor of shoes and distributes these shoes to Wal-Mart and Target. The three trading entities (client, Wal-Mart, and Target) each use different EDI templates A, B, and C, respectively, for sending electronic data files to each other. For purchase orders, assume the client is interested in (and therefore desires to track and store in a database) the name of the customer or trading partner (TP), the shipping address, the purchase order number, the product identifier, and quantity. These pieces of information correspond to the key field data that the client desires to extract from the purchase orders, and their locations within the formatted data file (e.g., formatted into XML) correspond to the key field information. The client knows that in Wal-Mart's purchase orders, which are formatted and received in template B, the desired information to be tracked is located in specific locations in the data file, and the client happens to know these specific locations. Currently, this information may be tracked by hand. For example, an employee of the client may individually open and read each purchase order. Depending on whether the purchase order is coming from Wal-Mart or Target (and thus depending on which EDI template is being used), he knows where to look on the purchasing order to find and track the desired information—i.e., he knows the location of the desired key field data. This is, of course, a very time consuming and labor-intensive process. The present invention aims to solve one or more of these and other problems.

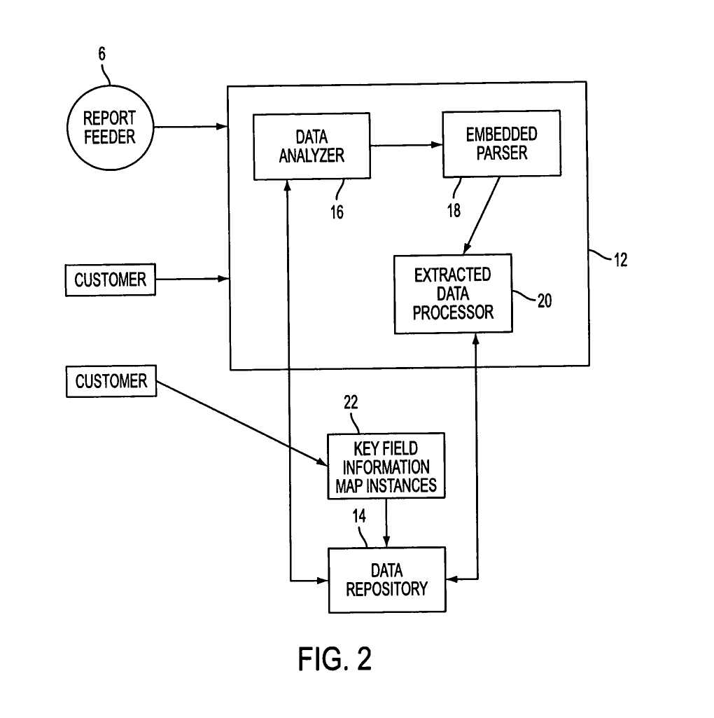

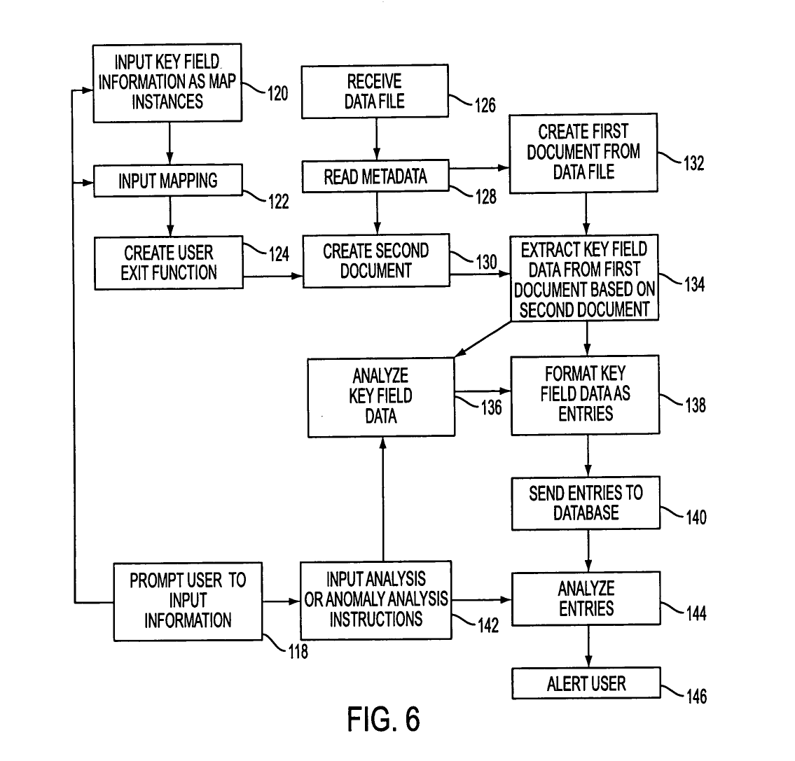

To solve these problems, the present invention provides for a method, software, and system for translating or extracting information from a data file. Referring now to FIGS. 2 and 6, an embodiment of the translator/extractor 12 and an exemplary process are shown. The translator/extractor 12 may include a data analyzer 16, an embedded parser or data extractor 18, an extracted data processor 20, and a data repository or information database 14. This translator/extractor 12 may be the one discussed previously, with respect to the broker emulator system. In the embodiment shown in FIG. 6, a client is prompted in step 118 to enter information. In step 120, the client enters key field information into the information database 14, preferably via a GUI, and preferably in the form of map instances 22. The key field information, as discussed, refers more generally to the generic information of which key fields in a given document should be tracked (i.e., from which key fields data should be extracted) and their location within the document with respect to other fields, for example. A very simple example of key field information may be “third field” or “fourth, ninth, and tenth fields.” A key field information map instance 22 is a manifestation of the key field information. A map instance 22 (as in FIG. 2) contains all the key field information (corresponding to key fields that the client wishes to track) for a given set of metadata. As will be discussed with respect to step 122, the client will create a function that corresponds or maps the content of the metadata to a particular map instance 22. In other words, each map instance 22 is such that, for some predetermined metadata content of a formatted data file, the key field data will be extracted from the formatted data file based on the key field information in the map instance 22. For example, given that the metadata for a formatted data file includes information contents M, N, and O, there should be a map instance 22 corresponding to the metadata's information contents M, N, O that contains the appropriate key field information for that formatted data file (as previously input by the client in step 120).

The client preferably enters several map instances 22 (i.e., pieces of key field information), each one having a set of key field information corresponding to key field data that is desired to be extracted from particular documents having different templates. The templates could be EDI, XML, EDIFACT, or any other format template. For example, the client may know that Wal-Mart purchase orders have template B, as mentioned previously. The client desires to extract and track (from the purchase order data file) pieces of information X, Y, and Z (which may correspond to the purchase order number, the product identifier, and quantity, respectively). The client therefore inputs in step 120 a first key field information (or map instance 22) corresponding to information X, Y, Z. Next, in step 122, the client may correspond or map this map instance 22 to purchase orders coming from Wal-Mart. In other words, the client, in step 122, may input a mapping of each existing map instance 22 to the metadata that the client wishes to associate with that map instance 22.

Next, the client may know that purchase orders coming from Target have template C, as mentioned previously. The client desires to extract and track pieces of information X, Y, and Z, as above, as well as another field W (corresponding to shipping address). The client therefore inputs a second key field information (or map instance 22) corresponding to W, X, Y, and Z in step 120. Then, as before, the client may, in step 122, map or correspond this map instance 22 to purchase orders coming from Target. The client may enter many other key field information entries (or map instances 22) for other kinds or types of data files in step 120. For example, the key field information entries or map instances 22 may differ based on any feature(s) of the metadata, such as the sender of the data file (as discussed above, the difference between sender Wal-Mart and sender Target), the recipient (e.g., whether the data file was intended for one internal department of the client versus another, such as the shipping department or the billing department), the date, the file type (such as whether the data file corresponds to a purchase order, an invoice, a remittance, or other file, as known in the art), or the file format. These key field information entries or map instances 22 are stored in the information database 14 and accessed by the data analyzer 16.

Step 120 may be entirely omitted if the information database 14 is pre-installed with a set of dummy map instances 22. In other words, instead of the client having to input, field by field, the key field information for each map instance 22, a set of generic map instances 22 may be pre-installed on the information database 14. In this embodiment, the client need only thumb through each of the pre-installed map instances 22 and choose the generic map instance 22 that she wishes to correspond to given metadata parameters. When she finds the generic map instance 22 that she wishes to use for a given metadata parameter, she may then do so by mapping or corresponding them in step 122.

Next, a user exit function is created in step 124. The user exit function is the function, stored in the information database 14, that actually maps a given metadata (or parameter set within the metadata) to a certain map instance 22. In other words, once the relevant map instances 22 are stored in the information database 14 (whether by input by the client or pre-installation), and after the client has entered the desired mapping, the user exit function is created in step 124 and stored in the information database 14.

When a data file and its corresponding metadata are first received in the data analyzer 16 (from, for example, the report feeder/collector 6) in step 126, the data analyzer 16 reads the metadata in step 128 and creates a first document based on the data file in step 132. For example, if the data file has an EDIFACT format, the data analyzer 16 may convert or translate the data file into a first document having an XML format. Next, the analyzer 16 invokes the user exit function and analyzes the file's metadata in step 128 based on the user exit function to determine which map instance 22 to use. For example, if the analyzer 16 determines from the metadata that the data file is a remittance from Target Store having as a recipient the client's billing department and having an EDIFACT format, the analyzer 16 may request from the information database 14 the map instance 22 corresponding/associated with this metadata in accordance with the user exit function. For example, for this given metadata information, the client may have entered key field information that corresponds to certain pieces of information in the data file, such as payment amount, bank routing information, bank account number, remittance number, correspondence address, and the name of a contact at Target or at the bank. The key field information is not, itself, the payment amount, bank routing information, etc., but rather the indication that the data inside the payment amount field in the remittance data file is desired to be extracted and stored. The key field data comprises the actual payment amount and bank routing information to be extracted as described below, based on the key field information.

Next, in step 130, the data analyzer 16 creates a second document, in one embodiment having the same format type as the first document, based on the map instance 22 received from the information database 14 based on the metadata and application of the user exit function. The second document, metaphorically speaking, is overlaid on top of the first document to pick and extract the desired information corresponding to the key field information or map instance 22. For example, the second document could be an XML document with empty fields corresponding to payment amount, bank routing information, etc.

Next, in step 134, the first and second documents may be sent to the embedded parser 18, which is configured to parse the first document by comparison with the key field information in the second document, so that the desired key field data in the key fields in the first document are extracted. Effectively, the embedded parser 18 puts the first and second documents together and extracts from the first document (which is based on the original data file) whatever data the client requested when the client created the key field information for that particular metadata. So, in the example previously given, the embedded parser 18 would then extract the actual payment amount, bank routing information, etc. from the first document. The embedded parser 18 may use XPath to extract the key field data.

Typically, a parser in a computer compiler is a software module that breaks a computer language statement or data file into useful parts. In the present example, the embedded parser 18 uses the second document as a template for breaking the first document into useful parts: namely, the parts that correspond to the key field information input by the customer. The first document may have a format such that it has several fields, each field having a particular location within the first document and each field having an entry based at least on a content of the data file. The second document may have a format, preferably the same format as the first document, such that it comprises several fields, each field having a particular location within the second document based at least on the key field information input by the customer. In this example, the embedded parser 18 is configured to extract key field data from fields in the first document that are located in the same locations or relative positions as the corresponding fields in the second document. Field location is, of course, to be contrasted with byte location in the raw data file. In one embodiment of the present invention, the embedded parser 18 extracts the key field data from the first document based on the second document, which is created based on key field information or the map instance 22.

Next, this extracted key field data is sent to the extracted data processor 20. In step 138, the processor 20 formats the key field data for insertion, storage, and/or analysis (e.g., statistical, tracking, and/or analytical reports can be run against the stored data) in the information database 14, and may enter these key field data as individual entries in the information database 14. For example, the set of key field data corresponding to the extraction of data from the first document based on the second document may comprise one entry. The processor 20 then, in step 140, sends the formatted extracted data to the information database 14. The processor 20 may send the formatted extracted data to the same information database 14 in which the key field information was input by the client, or to a different information database 14. As discussed previously, this data may be directly sent from the extracted data processor 20 (the third element of the translator/extractor 12) to the information database 14, or this data may first be sent back to a report collector/feeder 6, which subsequently feeds the extracted key field data with or without a full copy of the original data file to the information database 14.

The key field data may be analyzed, in step 136, directly by the processor 20 before or after formatting the key field data for insertion into the information database 14 as entries. Further, the entries of the key field data in the information database 14 may be also analyzed, in step 144, by a processor such as the processor 20. For example, analyzing the entries may comprise identifying trading partner specific entries corresponding to a client-input trading partner name and analyzing those trading partner specific entries. For example, perhaps the client is interested in doing an analysis report on data files received from Wal-Mart. The client may, in step 142, input analysis instructions so that the entries in the information database 14 are searched and analyzed according to whether they contain Wal-Mart as a trading partner. Further, the entries could contain a date, a number, and/or a product identifier, and be analyzed according to one of these parameters, or any other parameter showing up in the metadata. For example, the client may be able to search for invoices sent from the client to Target from March 1-7, and subsequently analyze these entries.

Next, in the course of analyzing entries, the software/method according to the present invention may include alerting the client if there is an anomaly, as in step 146. For example, assume that the client receives, on average, three purchase orders for shoes per week from Wal-Mart. Assume that two weeks pass without any orders from Wal-Mart. The software may be configured to alert the client as to this fact (according to anomaly analysis instructions input in step 142). Further, assume the client is having difficulty paying its bills, because some customers consistently pay late. The client is interested in determining how long each customer takes to submit a remittance after receiving an invoice. Because the client has been able to extract the most pertinent information out of all data files/documents sent and received from the client via appropriate filter criteria and key field information, the information database 14 contains information, easily accessible and readable, about when each invoice was sent to each trading partner (TP), when that TP received or opened that file (in the case of functional acknowledgements, or FA, as known in the art), and when each TP submitted a remittance. Thus, a simple analysis algorithm can be applied to the entries in the information database 14 to determine which TPs pay their invoices late. Appropriate action can then be taken.

The client may, in step 142, enter anomaly analysis instructions into the same information database containing the key field information, and a GUI may, in step 118, prompt the client to enter such instructions. An anomaly analysis instruction may include identifying one or more entries as an anomaly when at least one of the following conditions is met.

1. A number of purchase order entries having a particular purchaser name and date is less than a customer-defined number. For example, the client may program the software to identify as an anomaly when a total number of purchase orders in a one-week span is less than three.

2. A number of purchase order entries having a particular product identifier and date is less than a customer-defined number. For example, the client may program the software to identify as an anomaly when the demand for a particular kind of shoe has unexplainably dropped to below a certain level.

3. More than one purchase order entry having a particular purchaser name has the same purchase order number.

4. In a set of purchase order entries having a particular purchaser name and otherwise consecutive purchase order numbers, at least one purchase order number is absent.

5. A trading partner takes more than a preset number of days to reply to or to submit a remittance in reply to an invoice.

There are, of course, many, many other possible conditions that a client may determine to be an anomaly. This is entirely client-specific, and the above examples are in no way intended to limit the scope of the present invention. Further, the above examples apply only to purchase order related transactions and entries. Clearly, another entire set of alerts and means for analysis exist for invoices, remittances, etc.

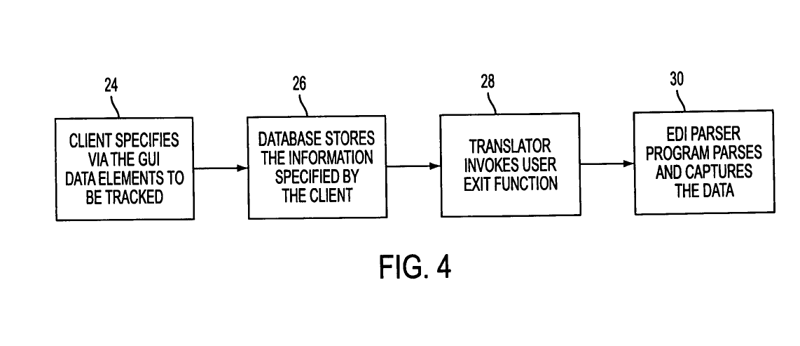

Referring now to FIGS. 2 and 4, the method may be designed so that no specific map instances 22 or trading partner profiles are required to be setup; the software may automatically extract the key field data. A system according to the present invention may include four modules: the translator/extractor 12 that is configured to call the user exit function, the client GUI which may be used by the client to provide the data fields that need to be tracked (i.e., the key field information), the information database 14 to store the above provided information, and the embedded parser program 18 (which may be an element inside the translator/extractor 12) to parse and capture the data (e.g., the key field data, according to the key field information).

The tracking document process may begin with the client GUI. A GUI may be provided to the client to input the fields that she wants to be tracked, as shown in step 24 in FIG. 4. The GUI may provide the client the flexibility to track the data fields in many ways. As an example, by entering appropriate key field information and mapping information, she may be able to track data fields in a transaction set irrespective of the trading partner (TP) or she can provide the TP name in addition to the transaction type and data fields and the data will be tracked for only that specific TP. As another example, when the client wishes to track data in a loop, the client may provide, during the mapping of the map instances 22 to given metadata parameters (as in step 122 in FIG. 6), the loop number and the parent loop segment names, as known in the art. For example, if the data field is the REF (reference) segment of an SLN (sub line item detail) loop, the client may provide “I” for the loop number and “SLN” for the parent loop name. Thus, for data files having metadata with “1” for the loop number and “SLN” for the parent loop name, a particular map instance 22 may be called by the user exit function such that the proper fields are tracked in the data file. A detailed analysis may have to be performed to find out if any data can be pre-populated into the GUI.

The information database 14 may then store the information (e.g., key field information) specified by the client, as shown in step 26 in FIG. 4. The information database 14 may comprise tables to store the information, such as key field information, that is captured by the client GUI. The database 14 may have columns to store the transaction type, data fields, loop numbers, loop segment names, sender identification and qualifier, receiver identification and qualifier, etc.

Next, in step 28, a user exit function may open a socket connection between the map instances 22 stored in the information database 14 and the embedded parser program 18, and the user exit function may include the following input parameters: input filename (fully qualified path), sender identification and qualifier, receiver identification and qualifier, transaction type, segment and element delimiters, etc., as discussed (i.e., parameters of the metadata). The user exit function may then send the key field information that it received from the map instance 22 to the embedded parser program 18 and wait for the embedded parser program 18 to create a second document based on the key field information, compare the first and second documents, and extract the key field data from the first document based on the second document. The file created by the embedded parser program 18 may either be an XML data file or a null value. The XML file may contain the key field information and the corresponding key field data in the document. The user exit function may then return the address of the XML data file to a map in the information database 14 that associates or maps a set of particular metadata parameters to one or more XML output files (i.e., files that result from the operation of the embedded parser program 18). This map may be accessible to the client via the GUI.

A simple XML map may be created that will format the XML file created above as an entry in the information database 14. The above created data field specific entries may be sent with the interchange, functional group, and document information messages that are currently being created in the information database 14.

In other terms, the embedded parser program 18 may receive parameters like input filename, etc., from the user exit function. Based on the parameters the embedded parser program 18 may perform a database lookup (e.g., of the set of map instances 22) and obtain the names of the segment and the data fields that need to be tracked. It may then parse the input file and capture the key field data, as shown in step 30 in FIG. 4. After the data for the various data fields are captured, the program may then create an XML document and return the XML document name to the user exit function.

A sample implementation of the present invention is Functional Acknowledgement (FA) reconciliation and notification reporting. (An FA reports on the system acknowledgement of a specific transaction). For example, as previously discussed, selected key field data can be extracted from data files as they pass through the broker emulator 2. For those files with FA, a return receipt may be available when the receiver receives the message. This receipt may also pass through the broker emulator 2 and its selected key field data extracted and entered into an information database. Then, it will be possible to analyze when a trading partner consistently is late in reading or responding to data files sent from the client (e.g., invoices, etc.). In the case of FA reconciliation and notification reporting, there are often two types of information or metadata in a data file or document, both of which are about documents where there was at least an attempt to deliver that document: 1) document content information, which may include interchange information, functional group information, and document information (as these relate to one of several EDI templates, as known by one skilled in the art) (Actual data elements may include sender, receiver, control number, date/time in the actual data.); and 2) accounting/tracking information, which may include the date or time that one of the above document life-cycle stages actually occurred (e.g., mailbox date/time, extraction date/time, acknowledgement date/time), file size, error status, etc.

A typical implementation of the present invention, as applied to FA reconciliation and notification reporting, may begin with the broker emulator 2 sending metadata to the report collector/feeder 6, and a record is made of the sender, receiver, application reference, sender reference, and service reference, etc. (i.e., information in the metadata). Next, the translator/extractor program 12 extracts the data elements previously mentioned based on key field information in the map instance 22 called by the user exit function. Next, the extracted key field data, once formatted, are stored as entries in the information database 14, and then an association is made between the filenames of these entries and their original metadata. The data or entries stored in the database 14 may be analyzed by the client, as discussed, enabling FA Transaction Reporting and allowing clients to monitor their FA performance and take timely action as appropriate via a proactive notification feature based on the hub policy.

As noted above, embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A method of extracting data, comprising:
receiving a data file from a data source, said data file having metadata comprising at least one of file name, sender identification information, receiver identification information, transaction type, and file format;
obtaining a first document based at least on said data file;
selecting key field information from a first information database based at least in part on said metadata of said data file;
obtaining a second document based on said key field information;
extracting key field data, corresponding to said key field information, from said first document based on said second document; and
sending said key field data to a second information database.

2. The method as in claim 1, further comprising formatting said key field data for said second information database.

3. The method as in claim 1, wherein said key field information is input into said first information database by a customer based at least in part on said metadata.

4. The method as in claim 3, wherein a first key field information is input into said first information database by said customer for data files having metadata having a first parameter, and a second key field information is input into said first information database by said customer for data files having metadata having a second parameter.

5. The method as in claim 4, wherein said first parameter is a sender identification information corresponding to a first sender, and said second parameter is a sender identification information corresponding to a second sender.

6. The method as in claim 4, wherein said first parameter is a receiver identification information corresponding to a first receiver, and said second parameter is a receiver identification information corresponding to a second receiver.

7. The method as in claim 4, wherein said first parameter is a first transaction type, and said second parameter is a second transaction type.

8. The method as in claim 4, wherein said first parameter is a first file format, and said second parameter is a second file format.

9. The method as in claim 3, further comprising prompting said customer to input said key field information.

10. The method as in claim 9, wherein said prompting comprises prompting said customer to input said key field information via a graphical user interface.

11. The method as in claim 1, wherein said first document has a format different from said data file.

12. The method as in claim 1, wherein said first information database is said second information database.

13. The method as in claim 1, wherein said first and second documents have an XML format.

14. The method as in claim 1, wherein said data file has one of an EDI, EDIFACT, ANSI X12, and a flat file format.

15. The method as in claim 1, further comprising analyzing said key field data.

16. The method as in claim 15, further comprising creating entries in said second information database based on said key field data sent to said second information database.

17. The method as in claim 16, wherein said entries each include a trading partner name and a date.

18. The method as in claim 17, wherein said analyzing comprises identifying trading partner specific entries corresponding to a customer-input trading partner name and analyzing said trading partner specific entries.

19. The method as in claim 16, wherein at least some of said entries include purchase order entries.

20. The method as in claim 16, wherein at least some of said entries include invoice entries.

21. The method as in claim 16, wherein at least some of said entries includes remittance entries.

22. The method as in claim 19, wherein said purchase order entries each include a name of a purchaser, a purchase order number, a product identifier, and a date.

23. The method as in claim 22, further comprising: analyzing said purchase order entries based on at least one of said purchaser name, purchase order number, product identifier, and date; and alerting said customer of an anomaly identified by said analyzing.

24. The method as in claim 23, further comprising: receiving anomaly analysis instructions from said first information database, wherein said anomaly analysis instructions are input into said first information database by said customer, and wherein said alerting said customer comprises alerting said customer of an anomaly based at least in part on said anomaly analysis instructions.

25. The method as in claim 24, wherein said anomaly analysis instructions include identifying one or a plurality of said entries in said second information database as an anomaly when at least one of the following conditions is met: a number of purchase order entries having a particular purchaser name and date is less than a customer-defined number; a number of purchase order entries having a particular product identifier and date is less than a customer-defined number; more than one purchase order entry having a particular purchaser name has the same purchase order number; in a set of purchase order entries having a particular purchaser name and otherwise consecutive purchase order numbers, at least one purchase order number is absent; and a trading partner takes more than a preset number of days to reply to or to submit a remittance in reply to an invoice.

26. The method as in claim 1, wherein said first document comprises a plurality of fields each having a location within said first document and each having an entry based at least on a content of said data file, wherein said second document comprises a plurality of fields each having a location within said second document based at least on said key field information, and wherein said extracting comprises extracting key field data from fields in said first document having locations corresponding to locations of said plurality of fields in said second document.

27. A program product for extracting data, said product comprising machine-readable program code for causing, when executed, a machine to perform the following method:
receiving a data file from a data source, said data file having metadata comprising at least one of file name, sender identification information, receiver identification information, transaction type, and file format;
obtaining a first document based at least on said data file;
selecting key field information from a first information database based at least in part on said metadata of said data file;
obtaining a second document based on said key field information;
extracting key field data, corresponding to said key field information, from said first document based on said second document; and
sending said key field data to a second information database.

28. A method of gathering customer-specific data from an information network, the information network having a broker configured to route a data file based at least in part on metadata associated with said data file, comprising:
reading said metadata in a broker emulator located in series with said broker;
obtaining first filter criteria at said broker emulator;
comparing said first filter criteria with said metadata;
if said metadata satisfies said first filter criteria, performing the following:
sending said metadata to a report collector connected to said broker;
comparing second filter criteria with said metadata;
if said metadata satisfies said second filter criteria, performing the following:
instructing said broker emulator to copy said data file associated with said metadata; and
at least one of translating and extracting data from said data file based at least in part on key field information.

29. The method as in claim 28, wherein said key field information is input by a customer.

30. The method as in claim 28, wherein said first filter criteria is input into an information database by a customer.

31. The method as in claim 28, wherein said extracting data from said data file comprises:
receiving said data file from at least one of said broker emulator and said report collector, wherein said metadata of said data file comprises at least one of file name, sender identification information, receiver identification information, transaction type, and file format;
obtaining a first document based at least on said data file;
selecting key field information from a first information database based at least in part on said metadata of said data file;
obtaining a second document based on said key field information;
extracting key field data, corresponding to said key field information, from said first document based on said second document; and
sending said key field data to a second information database.

32. The method as in claim 31, wherein said key field information is input into said first information database by said customer based at least in part on said metadata.

33. A program product for gathering customer-specific data from an information network, the information network having a broker configured to route a data file based at least in part on metadata associated with said data file, said product comprising machine-readable program code for causing, when executed, a machine to perform the following method:
reading said metadata in a broker emulator located in series with said broker;
obtaining first filter criteria at said broker emulator;
comparing said first filter criteria with said metadata;
if said metadata satisfies said first filter criteria, performing the following:
sending said metadata to a report collector connected to said broker;
comparing second filter criteria with said metadata;
if said metadata satisfies said second filter criteria, performing the following:
instructing said broker emulator to copy said data file associated with said metadata; and
at least one of translating and extracting data from said data file based at least in part on key field information.

34. A method of gathering customer-specific data from an information network, the information network having a broker configured to route a data file based at least in part on metadata associated with said data file, comprising:
reading said metadata in a broker emulator located in series with said broker;
obtaining filter criteria at said broker emulator;
comparing said filter criteria with said metadata; and
if said metadata satisfies said filter criteria, at least one of translating and extracting data from said data file based at least in part on key field information input by a customer.

35. The method as in claim 34, wherein said filter criteria is input into an information database by said customer.

36. The method as in claim 34, wherein said extracting data from said data file comprises:
receiving said data file from at least one of said broker emulator and said report collector, wherein said metadata of said data file comprises at least one of file name, sender identification information, receiver identification information, transaction type, and file format;
obtaining a first document based at least on said data file;
selecting key field information from a first information database based at least in part on said metadata;
obtaining a second document based on said key field information;
extracting key field data, corresponding to said key field information, from said first document based on said second document; and
sending said key field data to a second information database.

37. The method as in claim 36, wherein said key field information is input into said first information database by said customer based at least in part on said metadata.

38. A system for extracting data from a data file having metadata comprising at least one of file name, sender identification information, receiver identification information, transaction type, and file format, comprising:
a data analyzer configured to create a first document based at least on said data file;
an information database connected to said data analyzer and configured to store at least two key field information instances and a mapping of said key field information instances as a function of said metadata; and
a data extractor connected to said data analyzer and configured to: a) select a key field information instance stored in said information database based on said mapping; b) create a second document based on said key field information instance; and c) extract key field data, corresponding to said key field information, from said first document based on said second document.

39. The system as in claim 38, further comprising an extracted data processor configured to analyze said key field data extracted by said data extractor.

40. The system as in claim 39, wherein said extracted data processor is configured to format said key field data for storage as entries in a second information database.

41. The system as in claim 40, wherein said extracted data processor is configured to analyze said entries in said second information database.

42. The system as in claim 38, wherein said key field information is input by a customer.

43. The system as in claim 42, further comprising a graphical user interface connected to said information database and configured so that said key field information is input by said customer by said graphical user interface.

44. A system for gathering customer-specific data from an information network, comprising:
a broker configured to route a data file based at least in part on metadata associated with said data file;
an information database configured to store filter criteria;
a broker emulator connected to said information database and configured: a) to read said metadata of said data file; b) to compare said metadata to said filter criteria; and c) if said metadata satisfies said filter criteria, to copy said data file; and
a translator configured to at least one of translate said copy of said data file and extract data from said copy of said data file.

45. The system as in claim 44, wherein said filter criteria is input by a customer.

46. The system as in claim 45, further comprising a graphical user interface connected to said information database and configured so that said filter criteria is input by said customer by said graphical user interface.

47. The system as in claim 44, wherein said translator comprises:
a data analyzer configured to create a first document based at least on said copy of said data file;
an information database connected to said data analyzer and configured to store at least two key field information instances and a mapping of said key field information instances as a function of said metadata; and
a data extractor connected to said data analyzer and configured to: a) select a key field information instance stored in said information database based on said mapping; b) create a second document based on said key field information instance; and c) extract key field data, corresponding to said key field information, from said first document based on said second document.
